(19) United States
(12) Patent Application Publication
(10) Pub. No.: US 2025/0218688 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Yun KIM, Suwon-si (KR); Kwang Hee NAM, Suwon-si (KR); Joon Yeob CHO, Suwon-si (KR); Young Ghyu AHN, Suwon-si (KR); Jea Yeol CHOI, Suwon-si (KR)

(73) Assignee: SAMSUNG ELECTRO-MECHANICS CO., LTD., Suwon-si (KR)

(21) Appl. No.: 18/983,596

(22) Filed: Dec. 17, 2024

(30) Foreign Application Priority Data
Dec. 28, 2023 (KR) 10-2023-0195311

(51) Int. Cl. H01G 4/30; H01G 4/012; H01G 4/12; H01G 4/232

(52) U.S. Cl. CPC H01G 4/30; H01G 4/012; H01G 4/1227; H01G 4/232

(57) ABSTRACT

A multilayer electronic component according to an example embodiment of the present disclosure may include: a body including a plurality of capacitance formation portions including first dielectric layers and internal electrodes alternately arranged in a first direction. An intermediate layer disposed is between the adjacent capacitance formation portions and includes a second dielectric layer. An external electrode is disposed on the body and connected to the internal electrode. The first and second dielectric layers may include a plurality of grains and pores. An average grain size of the first dielectric layer may be smaller than an average grain size of the second dielectric layer. A porosity of the first dielectric layer may be lower than a porosity of the second dielectric layer.

### CROSS-REFERENCE TO RELATED APPLICATION(S)

This application claims the benefit of priority to Korean Patent Application No. 10-2023-0195311 filed on Dec. 28, 2023, in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a multilayer electronic component, is a chip-type condenser, mounted on the printed circuit boards of various types of electronic product, such as image display devices including a liquid crystal display (LCD) and a plasma display panel (PDP), computers, smartphones and mobile phones, and serves to charge or discharge electricity therein or therefrom.

The multilayer ceramic capacitor may be used as a component in various electronic devices due to having a small size, ensuring high capacitance and being easily mounted. With the miniaturization and implementation of high output power of various electronic devices such as computers and mobile devices, demand for miniaturization and high capacitance of multilayer ceramic capacitors has also been increasing.

In general, MLCCs have a structure having the same width and thickness. In order to achieve high capacitance, it is necessary to increase the number of layers by thinning a dielectric layer and internal electrodes. However, due to technical limitations in thinning the dielectric layer and internal electrodes, it may not be easy to implement a high number of layers with a structure having the same width and thickness of a chip. Accordingly, High-Profile Ceramic Capacitor (HPCC) products implementing a high number of stacked layers by increasing a thickness of the chip have been developed.

Since the HPCC has a structure having a thickness T thereof thicker than a width W thereof, the HPCC may increase the number of layers as compared to general MLCCs having the same width and thickness, and may easily achieve high capacitance.

However, since the HPCC has the structure having the thickness T thicker than the width W thereof, there may be a problem in that chip shape distortion could easily occur due to stress generated during a pressing and cutting process.

### SUMMARY

An aspect of the present disclosure is to provide a multilayer electronic component having excellent reliability.

An aspect of the present disclosure is to prevent defects in which a shape of a body is distorted.

An aspect of the present disclosure is to provide a multilayer electronic component that is compact and which has excellent capacitance.

However, the aspects of the present disclosure are not limited to the above-described contents, and may be more easily understood in the process of describing specific embodiments of the present disclosure.

A multilayer electronic component according to an example embodiment of the present disclosure may include: a body including a plurality of capacitance formation portions including first dielectric layers and internal electrodes alternately arranged in a first direction, and an intermediate layer disposed between adjacent capacitance formation portions and including a second dielectric layer, and including first and second surfaces opposing each other in the first direction, third and fourth surfaces connected to the first and second surfaces and opposing each other in a second direction, and fifth and sixth surfaces connected to the first to fourth surfaces and second direction in a third direction; and an external electrode disposed on the body and connected to the internal electrode, and the first and second dielectric layers may include a plurality of grains and pores, and an average grain size of the first dielectric layer may be smaller than an average grain size of the second dielectric layer, and a porosity of the first dielectric layer may be lower than a porosity of the second dielectric layer.

One of the various effects of the present disclosure is to provide a multilayer electronic component having excellent reliability.

One of the various effects of the present disclosure is to provide a multilayer electronic component configured to suppress defects in which a shape of a body is distorted.

One of the various effects of the present disclosure is to provide a multilayer electronic component that is compact and has excellent capacitance.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a cross-sectional view taken along line I-I′ of FIG. 1;

FIG. 3 is a cross-sectional view taken along line II-II′ of FIG. 2;

FIG. 4 is an exploded perspective view schematically illustrating an exploded body of a multilayer electronic component;

FIG. 5 is an enlarged view of region K1 of FIG. 3;

FIG. 6 is an enlarged view of region K2 of FIG. 3;

FIG. 7 is a cross-sectional view illustrating the distortion of a body; and

FIG. 8 is a view corresponding to FIG. 2 of a multilayer electronic component according to an example embodiment of the present disclosure.

### DETAILED DESCRIPTION

Hereinafter, example embodiments of the present disclosure will be described

with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. Therefore, in the drawings, the shapes and dimensions of elements may be exaggerated for clarity, and the same reference numerals will be used throughout to designate the same or like elements.

In addition, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. In addition, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be defined as a thickness T direction, a second direction may be defined as a length L direction, and a third direction may be defined as a width W direction.

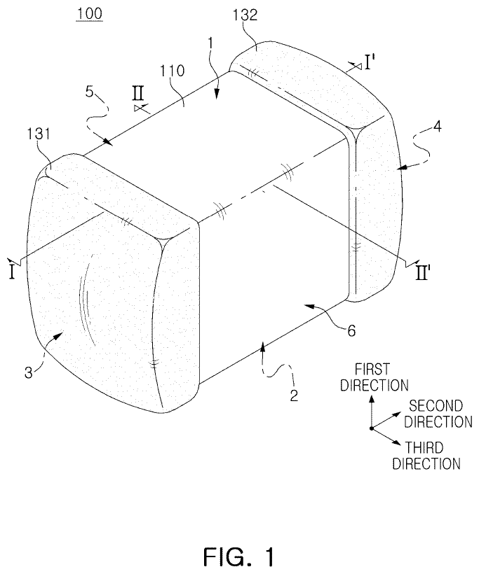

FIG. 1 is a schematic perspective view of a multilayer electronic component according to an example embodiment of the present disclosure.

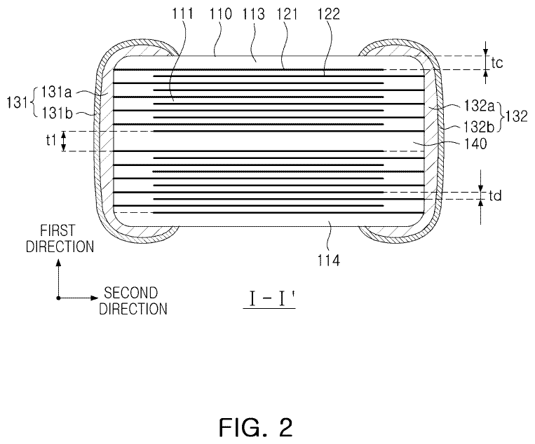

FIG. 2 is a cross-sectional view taken along line I-I′ of FIG. 1.

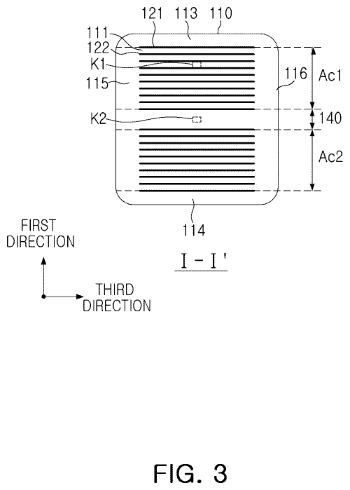

FIG. 3 is a cross-sectional view taken along line II-II′ of FIG. 2.

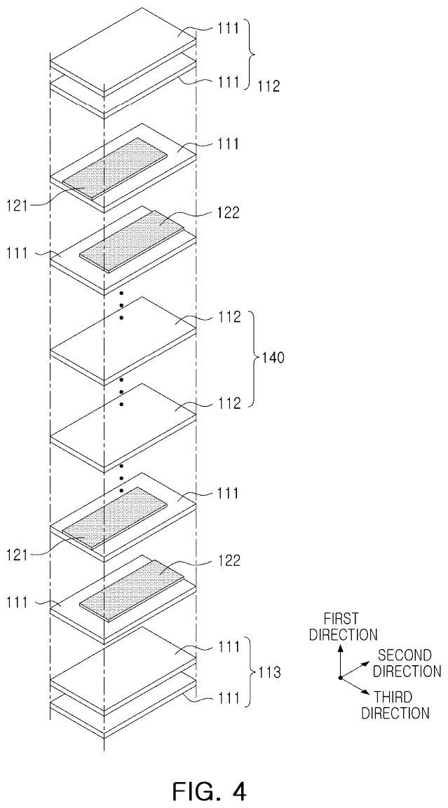

FIG. 4 is an exploded perspective view schematically illustrating an exploded body of a multilayer electronic component.

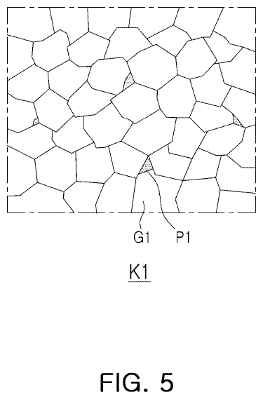

FIG. 5 is an enlarged view of region K1 of FIG. 3.

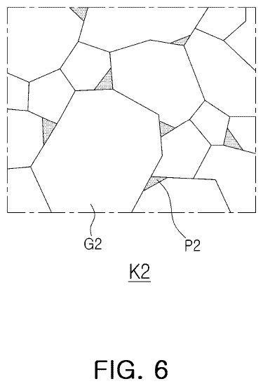

FIG. 6 is an enlarged view of region K2 of FIG. 3.

Referring to FIGS. 1 to 6, a multilayer electronic component 100 according to an example embodiment of the present disclosure may include: a body including a plurality of capacitance formation portions Ac1 and Ac2 including first dielectric layers 111 and internal electrodes 121 and 122 alternately arranged in a first direction, and an intermediate layer 140 disposed between the adjacent capacitance formation portions Ac1 and Ac2 and including a second dielectric layer 112, and including first and second surfaces 1 and 2 opposing each other in the first direction, third and fourth surfaces 3 and 4 connected to the first and second surfaces and opposing each other in a second direction, and fifth and sixth surfaces 5 and 6 connected to the first to fourth surfaces and opposing each other in a third direction; and external electrodes 131 and 132 disposed on the body and connected to the internal electrodes, and the first and second dielectric layers include a plurality of grains G1 and G2 and pores P1 and P2, and an average grain size of the first dielectric layer is smaller than an average grain size of the second dielectric layer, and a porosity of the first dielectric layer may be lower than a porosity of the second dielectric layer.

As described above, since High-Profile Ceramic Capacitor (HPCC) products implementing a high number of stacked layers by increasing a thickness of the multilayer electronic component have a structure in which a thickness T thereof is thicker than a width W thereof, the HPCC products may increase the number of stacked layers as compared to general MLCCs having the same width and thickness, thereby easily achieving high capacitance.

However, since the HPCC has a structure in which the thickness T is thicker than the width W, there may be a problem in that the chip shape may be easily distorted due to stress generated during a pressing and cutting process. Accordingly, there was a limitation in which it was difficult to increase the number of stacked layers by a level equal to or more than a certain number.

On the other hand, a multilayer electronic component 100 according to an example embodiment of the present disclosure may include an intermediate layer 140 disposed between adjacent capacitance formation portions Ac1 and Ac2 and including a second dielectric layer 112, and an average grain size of the first dielectric layer included in the capacitance formation portions Ac1 and Ac2 may be smaller than an average grain size of the second dielectric layer 112, and a porosity of the first dielectric layer 111 may be lower than a porosity of the second dielectric layer 112, thereby suppressing defects in which a shape of the body is distorted, and further increasing the number of stacked layers.

Hereinafter, each component included in the multilayer electronic component 100 according to an example embodiment of the present disclosure will be described.

There is no particular limitation on the specific shape of the body 110, but as illustrated, the body 110 may have a hexahedral shape or a shape similar thereto. Due to contraction of ceramic powder particles included in the body 110 during a sintering process, the body 110 may not have a hexahedral shape with entirely straight lines but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces and opposing each other in the third direction.

The body 110 may include a plurality of capacitance formation portions Ac1 and Ac2 in which capacitance is formed by including the first dielectric layer 111 and the internal electrodes 121 and 122 alternately arranged in the first direction. The capacitance formation portions Ac1 and Ac2 adjacent to each other may be arranged in the first direction, for example, with the intermediate layer 140 interposed therebetween.

In a state in which the first dielectric layers 111 forming the capacitance formation portions Ac1 and Ac2 are sintered, boundaries between adjacent dielectric layers 111 may be integrated so as to be difficult to identify without using a scanning electron microscope (SEM).

The first dielectric layer 111 may be formed by producing a ceramic slurry containing ceramic powder particles, an organic solvent and a binder, applying and drying the slurry on a carrier film to prepare a ceramic green sheet, and then sintering the ceramic green sheet. The ceramic powder particles are not particularly limited as long as sufficient electrostatic capacitance may be obtained therewith, and for example, barium titanate-based (BaTiO₃) powder particles may be used as the ceramic powder particles. For more specific examples, the ceramic powder particles may be one or more of BaTiO₃, (Ba₁₋ₓCaₓ)TiO₃ (0k<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1).

An average thickness td of the first dielectric layer 111 is not particularly limited. For example, the average thickness td of the first dielectric layer 111 may be 0.1 μm to 10 μm. Additionally, the average thickness td of the first dielectric layer 111 may be 0.1 μm to 0.6 μm in order to implement miniaturization and high capacitance of the multilayer electronic component.

Here, the average thickness td of the first dielectric layers 111 may refer to an average thickness of the first dielectric layers 111 disposed between the internal electrodes 121 and 122. The average thickness td of the first dielectric layer 111 may be measured by scanning images of first and second directional cross-sections of the body 110 with a scanning electron microscope (SEM) of 10,000× magnification. More specifically, the average thickness td of the first dielectric layer 111 may be obtained by measuring the thicknesses thereof at multiple points of one first dielectric layer 111, for example, 30 points equally spaced apart from each other in the second direction, and measuring an average value thereof. The 30 points equally spaced apart from each other may be designated in the capacitance formation portions Ac1 and Ac2. Additionally, when the average value is measured by extending an average value measurement up to 10 first dielectric layers 111, the average thickness of the first dielectric layer 111 may be further generalized.

The internal electrodes 121 and 122 may be arranged alternately with the first

dielectric layer 111, and may be arranged, for example, in a manner in which a pair of electrodes having different polarities, the first internal electrode 121 and the second internal electrode 122, may face each other with the first dielectric layer 111 interposed therebetween. The plurality of first internal electrodes 121 and the plurality of second internal electrodes 122 may be electrically separated from each other by the first dielectric layer 111 interposed therebetween.

The internal electrodes 121 and 122 may be spaced apart from the fifth and sixth surfaces 5 and 6 of the body 110, and may be connected to the third or fourth surfaces 3 and 4. For example, the plurality of first internal electrodes 121 may be spaced apart from the fourth to sixth surfaces 4, 5 and 6, respectively, and may be connected to the third surface 3. Additionally, the plurality of second internal electrodes 122 may be spaced apart from the third, fifth, and sixth surfaces 3, 5 and 6, respectively, and may be connected to the fourth surface 4.

A conductive metal included in the internal electrodes 121 and 122 may be one or more of nickel (Ni), copper (Cu), palladium (Pd), silver (Ag), gold (Au), platinum (Pt), tin (Sn), tungsten (W), titanium (Ti), and alloys thereof, and the present disclosure is not limited thereto.

The internal electrodes 121 and 122 may be formed by applying a conductive paste for internal electrodes including a conductive metal by a predetermined thickness on a ceramic green sheet and sintering the conductive paste. Additionally, the capacitance formation portions Ac1 and Ac2 may be formed by stacking and sintering ceramic green sheets on which the conductive paste for internal electrodes is applied. A method of printing the conductive paste for the internal electrodes may use a screen-printing method or a gravure printing method, and the present disclosure is not limited thereto.

An average thickness of the internal electrodes 121 and 122 does not need to be particularly limited. In this case, a thickness of the internal electrodes 121 and 122 may mean a first directional size of the internal electrodes 121 and 122. For example, the average thickness of the internal electrodes 121 and 122 may be 0.1 to 5 μm. Additionally, in order to implement miniaturization and high capacitance of the multilayer electronic component, the average thickness of the internal electrodes 121 and 122 may be 0.1 to 0.8 μm.

Here, the average thickness of the internal electrodes 121 and 122 may be measured by scanning the first and second directional cross-sections of the body 110 with the scanning electron microscope (SEM) of 10,000× magnification. More specifically, the average thickness of the internal electrodes 121 and 122 may be obtained by measuring the thicknesses at multiple points of one internal electrode 121 or 122, for example, 30 points equally spaced apart from each other in the second direction, and measuring an average value thereof. The 30 points equally spaced apart from each other may be designated in the capacitance formation portions Ac1 and Ac2. Additionally, when the average value is measured by extending an average value measurement up to 10 internal electrodes 121 and 122, the average thickness of the internal electrodes 121 and 122 may be further generalized.

The body 110 may include cover portions 113 and 114 disposed on the internal electrodes 121 and 122 disposed in an outermost portion based on the first direction. For example, the cover portions 113 and 114 may include a first cover portion 113 disposed on the internal electrodes 121 and 122 disposed in an uppermost portion based on the first direction, and a second cover portion 114 disposed on the internal electrodes 121 and 122 disposed in a lowermost portion based thereon, and the cover portions 113 and 114 may basically serve to prevent damage to the internal electrodes due to physical or chemical stress. The cover portions 113 and 114 may have the same configuration as the first dielectric layer 111 except that the cover portions 113 and 114 do not include the internal electrodes.

An average thickness tc of the cover portions 113 and 114 need not be particularly limited. However, in order to implement miniaturization and high capacitance of the multilayer electronic component 100, the average thickness tc of the cover portions 113 and 114 may be 20 μm or less. Here, the average thickness tc of the cover portions 113 and 114 means an average thickness of each of the first cover portion 113 and the second cover portion 114.

The average thickness tc of the cover portions 113 and 114 may refer to an average size of the cover portions 113 and 114 in the first direction, and may be an average value of the first directional sizes measured at five points equally spaced apart from each other in the first direction and second directional cross-sections of the body 110.

The capacitance formation portions Ac1 and Ac2 may include a first dielectric layer 111 and margin portions 115 and 116 disposed on both cross-sections of the internal electrodes 121 and 122 in the third direction. That is, the margin portions 115 and 116 may refer to a region between both ends of the internal electrodes 121 and 122 and a boundary surface of the body 110 in a cross-section obtained by cutting the body 110 in the first and third directions. In this case, the margin portions 115 and 116 may include a first margin portion 115 connected to the fifth surface 5 of the body 110 and a second margin portion 116 connected to the sixth surface 6 of the body 110.

The margin portions 115 and 116 may include the same material as that of the first dielectric layer 111 of the capacitance formation portions Ac1 and Ac2, except that the margin portions 115 and 116 do not include the internal electrodes 121 and 122.

The margin portions 115 and 116 may basically serve to prevent damage to the internal electrodes 121 and 122 due to physical or chemical stress.

The margin portions 115 and 116 may be formed by applying and sintering a conductive paste for internal electrodes, except for a region in which a margin portion is to be formed on the ceramic green sheet.

The average thickness of the margin portions 115 and 116 need not be particularly limited. However, in order to implement miniaturization and high capacitance of the multilayer electronic component 100, an average thickness of the margin portions 115 and 116 may be 20 μm or less. Here, the average thickness of the margin portions 115 and 116 refers to an average thickness of each of the first and second margin portions 115 and 116.

The average thickness of the margin portions 115 and 116 may refer to an average size of the margin portions 115 and 116 in the third direction, and may be a value obtained by averaging third directional sizes measured at five points spaced apart from each other by at equal intervals in the first and third directional cross-sections of the body 110.

The external electrodes 131 and 132 may be disposed on the third and fourth surfaces 3 and 4 of the body 110 and may extend to portions of each of the first, second, fifth and sixth surfaces 1, 2, 5 and 6. The external electrodes 131 and 132 may include a first external electrode 131 and a second external electrode 132 respectively connected to a plurality of first internal electrodes 121 and a plurality of second internal electrodes 122.

The external electrodes 131 and 132 may be formed of any material as long as the external electrodes have electrical conductivity such as a metal, and the specific material may be determined in consideration of electrical characteristics, structural stability, and the like, and the external electrodes 131 and 132 may further have a multilayer structure. For example, the external electrodes 131 and 132 may include conductive metals, and the conductive metals included in the external electrodes 131 and 132 may include copper (Cu), nickel (Ni), palladium (Pd), platinum (Pt), gold (Au), silver (Ag), lead (Pb), and/or alloys including the same.

The external electrodes 131 and 132 may include the first electrode layers 131a and 132a disposed on the third and fourth surfaces 3 and 4 of the body 110 and connected to the internal electrodes 121 and 122, and second electrode layers 132a and 132b disposed on the first electrode layers 131a and 132a.

The first electrode layers 131a and 132a may be formed by dipping the third and fourth surfaces 3 and 4 of the body 110 into a conductive paste for external electrodes including a conductive metal and glass and then sintering the third and fourth surfaces 3 and 4. Alternatively, first electrode layers 131a and 132a may be formed by transferring a sheet including the conductive metal and glass. Accordingly, the first electrode layers 131a and 132a may be sintering electrodes including the conductive metal and glass.

Additionally, the first electrode layers 131a and 132a may be, for example, a resin-based electrode including a conductive metal and a resin. The first electrode layers 131a and 132a may be formed by applying and curing a paste including a conductive metal and a resin.

The conductive metal included in the first electrode layers 131a and 132a may include copper (Cu), nickel (Ni), palladium (Pd), platinum (Pt), gold (Au), silver (Ag), lead (Pb), and/or alloys including the same, but the present disclosure is not limited thereto.

The second electrode layers 131b and 132b may improve mounting characteristics. The type of the second electrode layers 131b and 132b is not particularly limited, and the second electrode layers 131b and 132b may be plating layers including nickel (Ni), tin (Sn), palladium (Pd), and alloys including the same, and may be formed of a plurality of layers. The second electrode layers 131b and 132b may be, for example, a nickel (Ni) plating layer or a tin (Sn) plating layer, and may have a form in which the nickel (Ni) plating layer and the tin (Sn) plating layer are sequentially formed. Additionally, the second electrode layers 131b and 132b may include a plurality of nickel (Ni) plating layers and/or a plurality of tin (Sn) plating layers.

The drawings illustrate a structure in which a multilayer electronic component 100 has two external electrodes 131 and 132, but the present disclosure is not limited thereto, and the number or shape of the external electrodes 131 and 132 may be changed according to the shape of the internal electrodes 121 and 122 or other purposes.

A multilayer electronic component 100 according to an example embodiment of the present disclosure may include an intermediate layer 140 disposed between adjacent capacitance formation portions Ac1 and Ac2 and including a second dielectric layer 112, and an average grain size of the first dielectric layer included in the capacitance formation portions Ac1 and Ac2 may be smaller than an average grain size of the second dielectric layer 112, and a porosity of the first dielectric layer 111 may be lower than a porosity of the second dielectric layer 112.

The intermediate layer 140 may serve to disperse stress generated during a pressing and cutting process of a stack body and suppressing the shape of the body from being distorted. Since the intermediate layer 140 may have a smaller capacitance contribution than the first dielectric layer 111, the capacitance of the multilayer electronic component 100 may be lower than that of a multilayer electronic component having the same thickness and not having the intermediate layer 140. However, as the body 110 includes the intermediate layer 140, the shape of the body may be suppressed from being distorted, so that the number of stacked layers may be increased, and since the thickness of the body may be made thicker, high capacitance may be secured more easily.

Referring to FIG. 5 illustrating the microstructure of the first dielectric layer 111, and FIG. 6 illustrating the microstructure of the second dielectric layer 112, the first dielectric layer 111 may include a plurality of first grains G1 and first pores P1, and the second dielectric layer 112 may include a plurality of second grains G2 and second pores P2. An average size of the first grains G1 of the first dielectric layer 111 may be smaller than an average size of the second grains G2 of the second dielectric layer 112, and the porosity of the first dielectric layer 111 may be lower than the porosity of the second dielectric layer 112, so that the intermediate layer 140 may serve to disperse stress generated during the pressing and cutting process of the stacked body.

When the average grain size of the first dielectric layer 111 is defined as Gs1 and the average grain size of the second dielectric layer 112 is defined as Gs2, Gs2/Gs1does not need to be specifically limited. However, when Gs2/Gs1 satisfies 1.05<Gs2/Gs1<1.50, a stress dispersing effect of the intermediate layer 140 may be further improved to further suppress the distortion phenomenon of the body, and the number of stacked layers may be increased while minimizing the capacitance reduction due to the intermediate layer 140, thus being more advantageous in securing high capacitance.

When the porosity of the first dielectric layer 111 is defined as Ps1 and the porosity of the second dielectric layer 112 is defined as Ps2, Ps2/Ps1 does not need to be specifically limited. However, when Ps2/Ps1 satisfies 1.05<Ps2/Ps1<1.40, the stress dispersing effect of the intermediate layer 140 may be further improved, so that the distortion phenomenon of the body may be further suppressed, and the number of stacked layers may be increased while minimizing the capacitance reduction due to the intermediate layer 140, thereby being more advantageous in securing high capacitance.

The average grain size and the porosity may be measured by analyzing images scanned at 50k magnification using SEM made by ZEISS from cross-sections cut from a third directional center of the body in the first and second directions. The Feret diameter of the grains may be measured using Zootos, a grain size measurement software, from the scanned images, thus obtaining average sizes of each grains G1 and G2. Additionally, since the dielectric grains G1 and G2 and the pores P1 and P2 have a distinct difference in brightness, an area ratio of the pores P1 in the first dielectric layer 111 and an area ratio of the pores P2 in the second dielectric layer 112 may be measured from the scanned images of the SEM using an image analysis program, thus obtaining respective porosities thereof.

The second dielectric layer 112 may be formed by manufacturing a ceramic slurry including ceramic powder particles, an organic solvent and a binder and applying and drying the slurry on a carrier film to prepare a ceramic green sheet, and then sintering the ceramic green sheet. The ceramic powder particles are not particularly limited as long as sufficient electrostatic capacitance may be obtained therewith, but, for example, barium titanate (BaTiO₃) powder particles may be used as the ceramic powder particles. For a more specific example, the ceramic powder particles may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1). Meanwhile, a method for controlling an average grain size and a porosity of the first and second dielectric layers 111 and 112 is not particularly limited. For example, a binder content included in the ceramic green sheet for forming the second dielectric layer 112 may be made higher than a binder content included in the ceramic green sheet for forming the first dielectric layer 111, thus controlling the porosity.

Additionally, a size of the dielectric powder particles included in the ceramic green sheet for forming the second dielectric layer 112 may be made larger than a size of the dielectric powder particles included in the ceramic green sheet for forming the first dielectric layer 111, thus controlling the average grain size. However, the present disclosure is not limited thereto, and the average grain size and the porosity of the first and second dielectric layers may be controlled by varying the additive content, the type of ceramic powder particles, and the like.

The intermediate layer 140 may be formed by stacking one or more layers of the second dielectric layer 112. The intermediate layer 140 may be formed by stacking and sintering one or more ceramic green sheets for forming the second dielectric layer.

More specifically, one or more ceramic green sheets for forming the first dielectric layer may be stacked to stack the second cover portion 114, and a plurality of ceramic green sheets for forming the first dielectric layer to which a conductive paste for internal electrodes is applied may be stacked to stack the second capacitance formation portion Ac2, and then one or more ceramic green sheets for forming the second dielectric layer may be stacked to stack the intermediate layer 140. Then, a plurality of ceramic green sheets for forming the first dielectric layer to which conductive paste for internal electrodes is applied may be stacked to stack the first capacitance formation portion Ac1, and one or more ceramic green sheets for forming the first dielectric layer may be stacked to stack the first cover portion 113, thereby preparing a stack body.

In an example embodiment, when an average thickness of the body in the first direction is defined as T and an average thickness of the intermediate layer in the first direction is defined as t1, 0.0002<t1/T≤0.06 may be satisfied. Accordingly, the stress dispersing effect of the intermediate layer 140 may be further improved to further suppress the distortion phenomenon of the body, and the number of stacked layers may be increased while minimizing the capacitance reduction due to the intermediate layer 140, thereby being more advantageous in securing high capacitance.

In an example embodiment, the external electrodes 131 and 132 may include first and second external electrodes respectively disposed on the third and fourth surfaces, and the internal electrodes 121 and 122 may include a first internal electrode 121 connected to the first external electrode 131 on the third surface, and a second internal electrode 122 connected to the second external electrode 132 on the fourth surface.

In an example embodiment, when an average thickness of the body 110 in the first direction is defined as T and a distance from a point at which an extension line E6 of the sixth surface meets an extension line E1 of the first surface to a point at which the extension line E6 of the sixth surface meets an extension line E2 of the second surface is defined as Tr, 0.996≤T/Tr≤1 may be satisfied. When T/Tr is less than 0.996, it may be difficult to increase the number of stacked layers. Meanwhile, although it is ideal for T/Tr to be 1, when considering errors in the manufacturing process, or the like, 0.996≤T/Tr<1 may be satisfied.

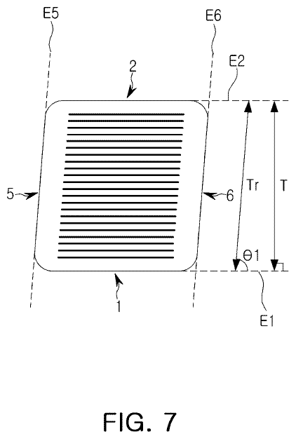

Referring to FIG. 7, a cross-sectional view illustrating the distortion of the body, a first directional thickness of the body 110 may be a length of a vertical straight line from the extension line E1 of the first surface to the extension line E2 of the second surface, and Tr may be a length of a straight line from a point in which the extension line E6 of the sixth surface meets the extension line E1 of the first surface to a point in which the extension line E6 of the sixth surface meets the extension line E2 of the second surface.

In an example embodiment, when an average thickness of the body in the first direction is defined as T, an average length of the body in the second direction is defined as L, and an average width in the third direction is defined as W, L>T>W may be satisfied. Accordingly, the capacitance of the multilayer electronic component may be easily improved.

The size of the multilayer electronic component does not need to be particularly limited. However, in general, as the size of the multilayer electronic component decreases, the probability of the distortion phenomenon of body increases. According to the present disclosure, when an intermediate layer is disposed between capacitance formation portions, even if the multilayer electronic component is compact, the distortion phenomenon of the body may be effectively suppressed, and specifically, the effect of suppressing the distortion phenomenon of the body according to the present disclosure may be remarkable in chips of 0603 size or less. Accordingly, in an example embodiment, when the average thickness of the body in the first direction is defined as T, the average length of the body in the second direction is defined as L, and the average width in the third direction is defined as W, T>W, T≤0.55 mm, L≤0.66 mm, and W≤0.33 mm may be satisfied.

T and W may be measured in the first and third direction cross-sections cut from a second directional center of the body, and an average value of first directional sizes of the body measured at five points spaced apart from each other by equal intervals in the third direction may be defined as T, and an average value of third directional sizes of the body measured at five points spaced apart from each other by equal intervals in the first direction may be defined as W. L may be measured in the first and second directional cross-sections cut from the third directional center of the body, and an average value of second directional sizes of the body measured at five points spaced apart from each other by equal intervals in the first direction may be defined as L.

In an example embodiment, when an average thickness of the body in the first direction is defined as T and an average width thereof in the third direction is defined as W, 1.1<T/W<1.8 may be satisfied. When T/W is 1.1 or less, it may be difficult to secure high capacitance, and when T/W is 1.8 or more, a thickness of the body relative to a width thereof may be significantly increased, making it difficult to mount the multilayer electronic component on a substrate.

In an example embodiment, the body 110 includes a cover portions 114 and 115 disposed on the internal electrodes disposed in the outermost portion based on the first direction, and when an average thickness of the intermediate layer 140 is defined as t1, an average thickness of the cover portions 114 and 115 is defined as tc, and an average thickness of the first dielectric layer 111 is defined as td, td<tc<t1 may be satisfied.

Additionally, in an example embodiment, when the average thickness of the intermediate layer 140 is defined as t1 and the average thickness of the first dielectric layer 111 is defined as td, 7<t1/td may be satisfied. An upper limit of t1/td does not need to be specifically limited, but may be, for example, 100 or less. Accordingly, the stress dispersing effect of the intermediate layer 140 may be further improved to further suppress the distortion phenomenon of the body, and the number of stacked layers may be increased while minimizing the capacitance reduction due to the intermediate layer 140, thereby being more advantageous in securing high capacitance.

The average thickness t1 of the intermediate layer 140 may refer to an average size of the intermediate layer 140 in the first direction. A thickness of the intermediate layer 140 may refer to a first directional distance between the intermediate layer 140 and two internal electrodes 121 and 122, closest to each other. Additionally, the average thickness t1 of the intermediate layer 140 may be an average value of first directional sizes measured at five points equally spaced apart from each other in images of the first and second directional cross-sections of the body 110 measured by the scanning electron microscope (SEM). Meanwhile, when a plurality of intermediate layers 140 are disposed, the average thickness t1 may refer to an average thickness of each of the plurality of intermediate layers 140.

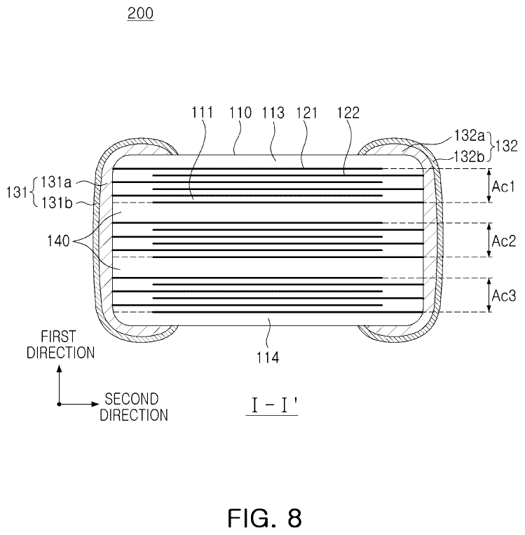

FIG. 8 is a view corresponding to FIG. 2 of a multilayer electronic component according to an example embodiment of the present disclosure.

Referring to FIG. 8, a body 210 of a multilayer electronic component 200 according to another example embodiment of the present disclosure may include three capacitance formation portions Ac1, Ac2 and Ac3 and two intermediate layers 140′ disposed between adjacent capacitance formation portions Ac1, Ac2 and Ac3.

In an example embodiment, the number of the plurality of capacitance formation portions Ac1, Ac2 and Ac3 may be three or more, and the number of intermediate layers 140′ may be two or more. An upper limit of the number of the intermediate layers 140′ is not particularly limited, but may be, for example, ten or less.

In an example embodiment, the plurality of capacitance formation portions Ac1, Ac2 and Ac3 may be disposed in the first direction.

In the case of the multilayer electronic component 200 according to an example embodiment of the present disclosure, since the plurality of intermediate layers 140′ are disposed, the stress distribution effect by the intermediate layers 140′ may be further improved, thereby further suppressing the distortion of the body.

Although the example embodiment of the present disclosure has been described in detail above, the present disclosure is not limited to the above-described embodiments and the accompanying drawings but is defined by the appended claims.

Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

What is claimed is:

1. A multilayer electronic component, comprising:
a body including a plurality of capacitance formation portions including a first dielectric layer and internal electrodes alternately arranged in a first direction, and an intermediate layer disposed between adjacent capacitance formation portions and including a second dielectric layer, and including first and second surfaces opposing each other in the first direction, third and fourth surfaces connected to the first and second surfaces and opposing each other in a second direction, and fifth and sixth surfaces connected to the first to fourth surfaces and second direction in a third direction; and
an external electrode disposed on the body and connected to the internal electrode,
wherein the first and second dielectric layers include a plurality of grains and pores, and
an average grain size of the first dielectric layer is smaller than an average grain size of the second dielectric layer, and a porosity of the first dielectric layer is lower than a porosity of the second dielectric layer.

2. The multilayer electronic component according to claim 1, wherein when the average grain size of the first dielectric layer is defined as Gs1 and the average grain size of the second dielectric layer is defined as Gs2, 1.05<Gs2/Gs1<1.50 is satisfied.

3. The multilayer electronic component according to claim 1, wherein when the porosity of the first dielectric layer is defined as Ps1 and the porosity of the second dielectric layer is defined as Ps2, 1.05<Ps2/Ps1<1.40 is satisfied.

4. The multilayer electronic component according to claim 1, wherein when an average thickness of the body in the first direction is defined as T and an average thickness of the intermediate layer in the first direction is defined as t1, 0.0002<t1/T≤0.06 is satisfied.

5. The multilayer electronic component according to claim 1, wherein the external electrode includes first and second external electrodes disposed on the third and fourth surfaces, respectively, and
the internal electrodes include a first internal electrode connected to the first external electrode on the third surface, and a second internal electrode connected to the second external electrode on the fourth surface.

6. The multilayer electronic component according to claim 5, wherein when an average thickness of the body in the first direction is defined as T and a distance from a point in which an extension line of the fifth surface meets an extension line of the first surface to a point in which the extension line of the fifth surface meets an extension line of the second surface is defined as Tr,
0.996≤T/Tr≤1 is satisfied.

7. The multilayer electronic component according to claim 6, wherein T and Tr satisfy 0.996≤T/Tr<1.

8. The multilayer electronic component according to claim 5, wherein when an average thickness of the body in the first direction is defined as T, an average length of the body in the second direction is defined as L, and an average width of the body in the third direction is defined as W,
L>T>W is satisfied.

9. The multilayer electronic component according to claim 5, wherein when an average thickness of the body in the first direction is defined as T, an average length of the body in the second direction is defined as L, and an average width of the body in the third direction is defined as W,
T>W, T≤0.55 mm, L≤0.66 mm, and W≤0.33 mm are satisfied.

10. The multilayer electronic component according to claim 5, wherein when an average thickness of the body in the first direction is defined as T and an average width in the third direction is defined as W,
1.1<T/W<1.8 is satisfied.

11. The multilayer electronic component according to claim 1, wherein the body includes a cover portion disposed on an internal electrode disposed in an outermost portion based on the first direction, and
when an average thickness of the intermediate layer is defined as t1, an average thickness of the cover portion is defined as tc, and an average thickness of the first dielectric layer is defined as td, td<tc<t1 is satisfied.

12. The multilayer electronic component according to claim 1, wherein when an average thickness of the intermediate layer is defined as t1 and an average thickness of the first dielectric layer is defined as td,
7≤t1/td is satisfied.

13. The multilayer electronic component according to claim 1, wherein a number of the plurality of capacitance formation portions is three or more, and
a number of the intermediate layers is two or more.

14. The multilayer electronic component according to claim 13, wherein the plurality of capacitance formation portions are arranged in the first direction.

15. A multilayer electronic component, comprising:
first and second capacitance formation portions, each including first and second internal electrodes with a first dielectric layer disposed therebetween; and
an intermediate layer comprising a second dielectric layer, disposed between the first and second capacitance forming portions,
wherein an average grain size of the first dielectric layer is smaller than an average grain size of the second dielectric material, and
a ratio of an average thickness t1 of the intermediate layer to an average thickness td of the first dielectric layer is greater than or equal to 7.

16. The multilayer electronic component of claim 15, wherein the first capacitance forming portion is disposed above the second capacitance forming portion in a thickness direction with the intermediate layer interposed therebetween,
wherein the electronic component further comprises a upper cover portion disposed above the first capacitance forming portion in the thickness direction and a lower cover portion disposed below the second capacitance forming portion, and
wherein an average thickness tc of the first and second cover portions satisfies td<tc<t1.

17. The multilayer electronic component according to claim 16, wherein an average distance T between a top surface of the upper cover portion and a bottom surface of the lower cover portion is greater than a width W of the capacitance forming portion and smaller than a length L of the capacitance forming portion.

18. The multilayer electronic component according to claim 17, wherein 1.1<T/W<1.8.

19. The multilayer electronic component according to claim 16, further comprising:
a first external electrode contacting the first internal electrode and spaced apart from the second internal electrode in a length direction; and
a second external electrode contacting the second internal electrode and spaced apart from the first internal electrode in the length direction.

20. The multilayer electronic component according to claim 16, wherein 0.0002<t1/T≤0.06, where T is an average distance between a top surface of the upper cover portion and a bottom surface of the lower cover portion.
